(19) United States
(12) Patent Application Publication
(10) Pub. No.: US 2013/0233595 A1
(43) Pub. Date: Sep. 12, 2013

(54) ELECTRODES AND APPLICATIONS

(71) Applicant: SELDON TECHNOLOGIES, INC., Windsor, VT (US)

(72) Inventors: Christopher H. COOPER, Windsor, VT (US); Daniel Iliescu, White River Junction, VT (US); Vardhan Bajpai, Lebanon, NH (US)

(73) Assignee: SELDON TECHNOLOGIES, INC., Windsor, VT (US)

(21) Appl. No.: 13/775,010

(22) Filed: Feb. 22, 2013

Related U.S. Application Data
(60) Provisional application No. 61/601,732, filed on Feb. 22, 2012.

(51) Int. Cl. H01B 5/00

(52) U.S. Cl. CPC H01B 5/002
USPC 174/126.2; 174/126.1; 156/281

(57) ABSTRACT

Disclosed herein is an electrode comprising, a capacitive carbon material located on at least one surface of a thin. The capacitive carbon material typically comprises functionalized ultra-long carbon nanotubes and optionally another carbon allotrope or mixture of carbon allotropes with sufficiently high active surface area. . Methods of forming such electrodes are also disclosed.

This application claims priority to U.S. Provisional Application No. 61/601,732, filed on Feb. 22, 2012, which is incorporated herein by reference in its entirety.

The present disclosure is directed to electrodes and methods of making the same. More particularly, the present disclosure is in the technical field of electrodes comprising carbon nanotubes, including ultra-long carbon nanotubes. In one embodiment, the present disclosure is directed to electrodes comprising carbon nanotubes for use in electronics, high frequency signal cables, capacitors and electrochemical cells. In another embodiment, the present disclosure is directed to electrodes comprising carbon nanotubes to be used for capacitive desalination and water softening applications.

The novel electrodes and method of making the electrodes disclosed herein address the shortcomings of carbon-based electrodes of prior art. In general, the selection of materials and methods of making electrodes operating in the presence of an electromagnetic field or applied voltage, are such that both the electrical conductivity and surface area available to the electromagnetic field depending on the application are maximized to the largest extent possible.

In electrodes of prior art, however, to maximize one characteristic, one would have to sacrifice the other. For example, other electrode materials may consist of metals and alloys that add weight to a device or system and are vulnerable to work hardening and hydrogen embrittlement. In another example, assembling an electrode from a high surface area activated carbon powder usually requires the use of binders. This leads inherently to a loss of active surface area due to coverage by the binder, in most cases a polymeric resin. At the other end of the spectrum, electrodes without binders generally exhibit relatively low surface areas, are brittle, fragile, and have low strength. The use of electrodes incorporating metallic materials in applications involving water containing dissolved solids is limited due to corrosion, and would require the use of expensive metals such as Pt or Au.

Advances in carbon nanotubes, specifically the development of ultra-long carbon nanotubes as well as in carbon aerogels, and activated carbons have made possible the construction of an all-carbon electrode whose capacitive layer exhibits a good mechanical integrity and can be attached to a graphite thin sheet substrate without the use of a polymeric resin-like binder. Thus, the Inventors have discovered that it is possible to make electrodes and capacitive elements to be used for electronics, high frequency signal cables, capacitors as well as for capacitive desalination and water softening applications. The present disclosure also relates to methods of making such electrodes. The electrodes contain ultra-long carbon nanotubes and another high surface area carbon material, such as carbon black or carbon aerogels. The mixture containing said ultra-long carbon nanotubes and another high surface area carbon material, such as carbon black or carbon aerogels is deposited onto a graphite thin sheet, which serves as current collectors.

### SUMMARY OF THE INVENTION

There is disclosed a corrosion-resistant electrode comprising: a capacitive carbon containing material comprising at least 5% of functionalized, ultra-long carbon nanotubes having a length ranging from 0.1 mm to 250 mm, wherein a majority of the ultra-long carbon nanotubes are capacitively coupled to one another. In one embodiment, the electrode has a tensile strength ranging from 10 mPa to 300 GPa.

There is also disclosed an electrode in which the capacitive carbon containing material further comprises (a) at least one other allotrope of carbon having a surface area of at least than 600 m²/g, (b) at least one other material having a fibrous or granular morphology, or a combination of (a) and (b).

In another embodiment, the disclosed electrodes may further comprising a graphite sheet substrate, and a metal foil attached to the graphite sheet, wherein the metal foil optionally contains at least one a wire attached to the metal foil to be connected to a circuit.

There is also disclosed a method of making a corrosion-resistant electrode described herein. In one embodiment, the method comprises
forming (a) a carbon containing mixture by dispersing and/or mixing in a liquid medium, functionalized, ultra-long carbon nanotubes described herein, optionally comprising at least one other allotrope of carbon having a surface area of at least than 500 m²/g, and/or at least one other material having a fibrous or granular morphology, and/or a graphite sheet used as substrate and current collector;
cleaning the surface of a graphite sheet followed by roughening the surface of the sheet to form a processed graphite sheet substrate;
depositing the mixture onto at least one surface of the said processed graphite sheet substrate;
pressing the carbon containing mixture onto at least one surface of the said processed graphite sheet substrate to form an electrode;
at least partially drying the carbon mixture that was deposited onto the processed graphite sheet substrates and that formed the electrode; and
clamping the electrode between at least two rigid plates followed by at least one heating step.

In one embodiment, the method allows for the capacitive carbon material to adhere to the surface of the processed substrate via a combination of mechanical and molecular level forces.

The foregoing and other features of the present disclosure will be more readily apparent from the following detailed description of exemplary embodiments, taken in conjunction with the attached drawings. It will be noted that for convenience all illustrations of devices show the height dimension exaggerated in relation to the width.

### BRIEF DESCRIPTION OF THE DRAWINGS

FIG. 1 is a perspective view of the electrode which constitutes an embodiment of the present invention.

FIG. 2 is a perspective view of a plate-like unit containing two electrodes of an embodiment of the present invention.

FIG. 3 is a perspective view of a stack of nine interconnected plate-like units of FIG. 2, each unit containing two electrodes of an embodiment of the present invention.

FIG. 4 is TGA experiment to illustrate the attachment of C-18 chains onto carbon nanotube surface.

FIG. 5: Water contact angles with the CNANO carbon nanotube films [A] CNT-HCL functionalization; [B] Raw CNT: mechano-chemical functionalization; [C] CNT-stearic acid functionalization

### DETAILED DESCRIPTION OF THE INVENTION

Definitions

The following terms or phrases used in the present disclosure have the meanings outlined below:

The term “nanotube” refers to a tubular-shaped, molecular structure generally having an average diameter in the inclusive range of 1-60 nm and an average length in the inclusive range of 0.1 μm to 250 mm.

The term “carbon nanotube” or any version thereof refers to a tubular-shaped, molecular structure composed primarily of carbon atoms arranged in a hexagonal lattice (a graphene sheet) which closes upon itself to form the walls of a seamless cylindrical tube. These tubular sheets can either occur alone (single-walled) or as many nested layers (multi-walled) to form the cylindrical structure.

The term “functional group” is defined as any atom or chemical group that provides a specific behavior. The term “functionalized” is defined as adding a functional group(s) to the surface of the nanotubes and/or the additional fiber that may alter the properties of the nanotube, such as zeta potential.

The terms “fused,” “fusion,” or any version of the word “fuse” is defined as the bonding of nanotubes, fibers, or combinations thereof, at their point or points of contact. For example, such bonding can be Carbon-Carbon chemical bonding including sp³ hybridization or chemical bonding of carbon to other atoms.

The terms “interlink,” “interlinked,” or any version of the word “link” is defined as the connecting of nanotubes and/or other fibers into a larger structure through mechanical, electrical or chemical forces. For example, such connecting can be due to the creation of a large, intertwined, knot-like structure that resists separation.

The terms “nanostructured” and “nano-scaled” refers to a structure or a material which possesses components having at least one dimension that is 100 nm or smaller. A definition for nanostructure is provided in The Physics and Chemistry of Materials, Joel I. Gersten and Frederick W. Smith, Wiley publishers, p382-383, which is herein incorporated by reference for this definition.

The phrase “nanostructured material” refers to a material whose components have an arrangement that has at least one characteristic length scale that is 100 nanometers or less. The phrase “characteristic length scale” refers to a measure of the size of a pattern within the arrangement, such as but not limited to the characteristic diameter of the pores created within the structure, the interstitial distance between fibers or the distance between subsequent fiber crossings. This measurement may also be done through the methods of applied mathematics such as principle component or spectral analysis that give multi-scale information characterizing the length scales within the material.

The term “nanomesh” refers to a nanostructured material defined above, and that further is porous. For example, in one embodiment, a nanomesh material is generally used as a filter media, and thus must be porous or permeable to the fluid it is intended to purify.

The terms “large” or “macro” alone or in combination with “scale” refers to materials that comprise a nanostructured material, as defined above, that have been fabricated using the methods described herein to have at least two dimensions greater than 1 cm. Non-limiting examples of such macro-scale, nanostructured material is a sheet of nanostructured material that is 1 meter square or a roll of nanostructured material continuously fabricated to a length of at least 100 meters. Depending on the use, large or macro-scale is intended to mean larger than 10 cm, or 100 cm or even 1 meters, such as when used to define the size of material made via a batch process. When used to describe continuous or semi-continuous methods, large scale manufacturing can encompass the production of material having a length greater than a meter, such as greater than one meter and up to ten thousand meters long.

The phrase “active material” is defined as a material that is responsible for a particular activity, such as removing contaminants from the fluid, whether by physical, chemical, bio-chemical or catalytic means. Conversely, a “passive” material is defined as an inert type of material, such as one that does not exhibit chemical properties that contribute to the removal contaminants when used as a filter media.

The phrase, “high surface area carbon” is intended to mean a carbon (including any allotrope thereof) having a surface area greater than 500 m²/g as determined by adsorption isotherms of carbon dioxide gas at room or 0.0° C. temperature. In one embodiment, the surface area of the high surface area carbon is greater than 1000 m²/g or up to and including 2500 m²/g. In one embodiment, the high surface area carbon may be any number between the range of 500 m²/g and 2500 m²/g, including increments of 50 m²/g from 500 m²/g and 2500 m²/g. In one embodiment, the high surface area carbon may be an activated carbon, wherein the level of activation sufficient to be useful in the present application may be attained solely from high the surface area; however, further chemical treatment may be performed to enhance the useful properties, such as adsorption properties.

The term “fiber” or any version thereof, is defined as an object of length L and diameter D such that L is greater than D, wherein D is the diameter of the circle in which the cross section of the fiber is inscribed. In one embodiment, the aspect ratio LID (or shape factor) of the fibers used may range from 2:1 to 100:1. Fibers used in the present disclosure may include materials comprised of one or many different compositions.

The term “particulate” or any version thereof, is defined as an object whose dimensions are roughly of the same order of magnitude in all directions.

The prefix “nano-” (as in “carbon nanotubes”) refers to objects which possess at least one dimension on the order of one billionth of a meter, 10⁻⁹ meters, to 100 billionths of a meter, 10⁻⁷ meters. Carbon nanotubes described herein generally have an average diameter in the inclusive range of from about 1-60 nm and an average length in the inclusive range from 0.1 mm to 250 mm, typically from 1 mm to 10 mm.

A “processed substrate” refers to a graphite sheet whose surface was first cleaned, for example with detergent; then rinsed, for example with water; dried; then rinsed again, for example with ethanol; and roughened, for example using 60-grit sandpaper to create asperities onto which the ultra-long carbon nanotubes attach.

The term “fluid” is intended to encompass liquids or gases.

The phrase “loaded carrier fluid,” refers to a carrier fluid that further comprises at least carbon nanotubes, and the optional components described herein, such as glass fibers.

The term “contaminant(s)” means at least one unwanted or undesired element, molecule or organism in the fluid. in one embodiment, contaminants include salts in water.

The term “removing” (or any version thereof) means destroying, modifying, or separating contaminants using at least one of the following mechanisms: particle size exclusion, absorption, adsorption, chemical or biological interaction or reaction.

The phrase “chemical or biological interaction or reaction” is understood to mean an interaction with the contaminant through either chemical or biological processes that renders the contaminant incapable of causing harm. Examples of this are reduction, oxidation, chemical denaturing, physical damage to microorganisms, bio-molecules, ingestion, and encasement.

The term “particle size” is defined by a number distribution, e.g., by the number of particles having a particular size. The method is typically measured by microscopic techniques, such as by a calibrated optical microscope, by calibrated polystyrene beads, by calibrated scanning probe microscope scanning electron microscope, or optical near field microscope. Methods of measuring particles of the sizes described herein are taught in Walter C. McCrone's et al., The Particle Atlas, (An encyclopedia of techniques for small particle identification), Vol. I, Principles and Techniques, Ed. 2 (Ann Arbor Science Pub.), which are herein incorporated by reference.

The phrase “corrosion-resistant” refers to material for which corrosion is thermodynamically unfavorable and/or has such slow kinetics that it is effectively immune to electrochemical corrosion under normal conditions. One example is graphite and other allotropes of carbon.

The phrases “chosen from” or “selected from” as used herein refers to selection of individual components or the combination of two (or more) components. For example, the nanostructured material can comprise carbon nanotubes that are only one of impregnated, functionalized, doped, charged, coated, and defective carbon nanotubes, or a mixture of any or all of these types of nanotubes such as a mixture of different treatments applied to the nanotubes.

In one embodiment, there is disclosed a corrosion-resistant electrode comprising: a capacitive carbon containing material comprising at least 5% of functionalized, ultra-long carbon nanotubes having a length ranging from 0.1 mm to 250 mm, wherein a majority of said ultra-long carbon nanotubes are capacitively coupled to one another, wherein said electrode has a tensile strength ranging from 10 mPa to 300 GPa.

In another embodiment, there is disclosed a corrosion-resistant, all-carbon electrode comprising a graphite sheet substrate having affixed to at least one side a carbon containing material, wherein the carbon containing material comprises at least two of (1) functionalized ultra-long carbon nanotubes, (2) other allotropes of carbon with sufficiently high active surface area, and optionally (3) other fibers or particulate materials.

The functionalized ultra-long carbon nanotubes are typically longer than 0.5 mm, such as from 0.1 mm to 250 mm. In addition, the other allotropes of carbon typically have an active surface area greater than 1000 m²/g, such as from 1000 to 2500 m²/g.

In one embodiment, the ultra-long carbon nanotube material may be in the geometrical form of a thread, a cable, a woven fabric, a non-woven material, a 3D printed part, a 3D woven form or any combination thereof. These geometrical forms may support current density up to 3×10⁹A/cm² at frequencies from 10 Hz to a 50 THz.

In one embodiment, a capacitive carbon containing material has a voltage across it ranging from 1 nV to 10 kV.

A method of making these types of electrodes is also disclosed. In one embodiment, the method comprises:

a) forming a carbon containing mixture by dispersing and/or mixing in a liquid medium, (1) functionalized ultra-long carbon nanotubes, (2) at least one other allotrope of carbon with sufficiently high active surface area, and optionally (3) additional fibers or particulate material;

b) degreasing the surface of a graphite sheet, for example first with laboratory-grade detergent and water and then with ethanol, followed by roughening the surface of the sheet, for example using 60-grit sand-paper, to create asperities onto which the ultra-long carbon nanotubes can attach;

c) depositing the mixture onto at least one surface of the processed graphite sheet substrate;

d) pressing the carbon-containing mixture onto at least one surface of the processed substrate to form an electrode;

e) at least partially drying the carbon mixture as deposited onto the electrically conductive substrates;

f) clamping the electrodes between two rigid plates and heating treating them;

g) covering the back of the electrodes, for example with a coating of lacquer.

According to one embodiment of the present disclosure, the carbon nanotube-based electrode comprises:

a) a capacitive carbon layer comprising: (1) functionalized ultra-long carbon nanotubes, (2) other carbon allotropes with sufficiently high active surface area such as activated carbon and/or carbon aerogels, and optionally (3) other fibers and/or particulate materials;

b) a processed substrate having a capacitive carbon layer affixed to one side;

c) a metal foil attached to the free surface of the processed substrate via electroplating and soldering; and

d) at least one wire attached to the metal foil to enable the electrode to be connected in an electrical circuit.

In one embodiment, the functionalized ultra-long carbon nanotubes are longer than about 0.5 mm, such as from about 0.1 mm to about 250 mm, typically between about 1 mm and about 10 mm. In addition, the other allotropes of carbon contributing to the overall capacitance of the electrode have an active surface area greater than about 500 m²/g, such as from about 1000 to about 2500 m²/g.

In one embodiment, the allotropes of carbon are in powder form and are present in the carbon containing material in an amount equal or greater than one gram per one Farad of double layer capacitance. For example, in one embodiment the capacitance per unit mass of carbon containing material ranges from about 80 to about 120 Farad/g.

In another embodiment, the ultra-long carbon nanotubes are present in the carbon containing material in an amount of at least 5% of the total mass of all other allotropes of carbon in powder form.

In one embodiment, the electrodes disclosed herein operate as follows. A pair of said electrodes, with their respective high-surface area carbon layers facing each other and separated such that a small gap exists between them, is placed in water containing dissolved solids. Under an applied potential difference (voltage), the ions in the solution, move towards the opposite polarity electrode, creating an ion-rich layer at the electrode-liquid interface (double layer). Subsequently, the water between the electrodes becomes less contaminated with ionic impurities. Upon removing the applied voltage or reversing polarity, the ions return to the solution, releasing the energy stored in the double layer.

Higher electrode surface areas are desirable because they can attract more ions and subsequently increase the rate at which the ions are removed from the processed water.

In one embodiment, a spacer material may be used to separate the electrodes while allowing water to occupy the space between them.

In another embodiment, the electrodes could be used in conjunction with ion-exchange membranes and a spacer material.

Unlike prior art electrodes, a unique property of the electrodes according to one embodiment of the present disclosure is that since they are primarily made from carbon (except for the metal strip on the dry side) they do not readily corrode and can be used in a corrosive environment such as salt or brackish water. Such a property is desirable for desalination applications.

Another unique property is that the capacitive carbon layer containing the ultra-long carbon nanotubes and at least one other high-surface area carbon allotrope is attached to the processed substrate without any resin-like binder by virtue of the mechanical and surface forces (Van der Waals type) between the carbon nanotubes and the asperities created on the surface of the processed substrate.

A method of making these types of electrode is also disclosed. In one embodiment, the method comprises:

a) forming a carbon containing mixture by dispersing and/or mixing in a liquid medium, such as an alcohol (e.g., ethanol, methanol, propanol, and combinations thereof), water, or combinations thereof, (1) functionalized ultra-long carbon nanotubes, (2) at least one other allotrope of carbon with sufficiently high active surface area, and optionally (3) other fibers and or particulate materials.

b) cleaning the surface of a graphite sheet, for example first with laboratory-grade and water and then with ethanol, followed by roughening the surface of the sheet, for example using 60-grit sand-paper, to create asperities onto which the carbon nanotubes will attach;

c) depositing the mixture onto a sacrificial porous substrate such as a woven or nonwoven polymer fabric;

d) affixing the sacrificial substrate with the carbon mixture to the processed graphite foil such that the carbon mixture is in contact with processed substrate.

e) pressing the carbon containing mixture onto at least one surface of the processed substrate to form an electrode;

f) at least partially drying the carbon mixture as deposited onto the processed substrate;

g) clamping the electrodes between two rigid plates and heating treating them;

h) covering the back of the electrodes, for example with a coating of lacquer.

In one embodiment, the electrodes may be heated for a time ranging from 10-40 minutes at a temperature ranging from 100-300° C. in air or in an inert atmosphere.

As previously explained, by virtue of using ultra-long carbon nanotubes, defined as having a length of about 0.1 mm to about 250 mm, or typically from about 1 mm to about 10 mm, the capacitive carbon layer containing the said functionalized ultra-long carbon nanotubes and at least one other high-surface area carbon allotrope adheres to the surface of the processed substrate via mechanical interactions and molecular level forces rather than a binder.

The present disclosure is further illustrated by the following non-limiting examples, which are intended to be purely exemplary of the disclosure.

### EXAMPLES

### A. Electrode Fabrication

In one embodiment, electrodes according to the present disclosure were made as follows.

Carbon nanotubes with lengths ranging from 1 mm to 5 mm were first functionalized by rinsing them with concentrated nitric acid heated to 80° C. for 30-45 minutes. This acid treatment resulted in the attachment of primarily carboxyl and hydroxyl groups to the surface of the nanotubes.

A carbon material comprising a mixture of the previously functionalized, ultra-long carbon nanotubes and high-surface activated carbon (Nuchar® RGC Powder Carbon, MeadWestVaco, Richmond, Va.), having a surface area ranging from 1500 to 1800 m²/g, was dispersed in ethanol and deposited onto a non-woven polymer-fiber cloth.

The cloth with the carbon layer was placed on top of the processed substrate (thickness 0.4 mm) with the carbon layer in contact with the processed substrate. The processed substrate was a graphite foil whose surface was first degreased using laboratory grade detergent and water, wiped dry with a paper towel and then rinsed again with ethanol. After drying, one side of the graphite foil was sanded thoroughly in a random pattern using 60 grit sand-paper to create microscopic surface detail. This process in conjunction with the ultra-long functionalized carbon nanotubes assisted the capacitive carbon layer to adhere to the processed graphite foil substrate without the use of binder.

This layered structure of the graphite foil substrate, carbon mixture layer, and the sacrificial substrate was partially dried and then pressed using a hydraulic press between two flat stainless steel plates. A 50 to 60 kN force was applied for about 30 to 60 seconds. The assembly was then removed from the press and the polymer cloth was peeled off like a sticker to reveal the capacitive carbon layer adhered to the graphite foil substrate as a thin uniform black film. This carbon film was further gently rolled using a hand roller. Extra carbon sticking out around the edges of the graphite foil substrate was carefully removed to produce a clean-looking electrode with a well-defined carbon film attached to it.

Next, the electrodes were placed alternating between layers of woven carbon-fiber cloth and clamped between two rigid stainless steel plates. This assembly was then placed in an oven and the temperature was gradually raised to about 200° C. The electrodes were kept at this temperature for 30-45 minutes.

Following the heat treatment, a copper foil was attached to the free surface of the graphite foil to allow the attachment of wires necessary to connect the electrodes in an electrical circuit. After the attachment of the copper foil and the subsequent soldering of wires to the copper foil, the entire free surface of the graphite foil, including the copper tab was coated with lacquer.

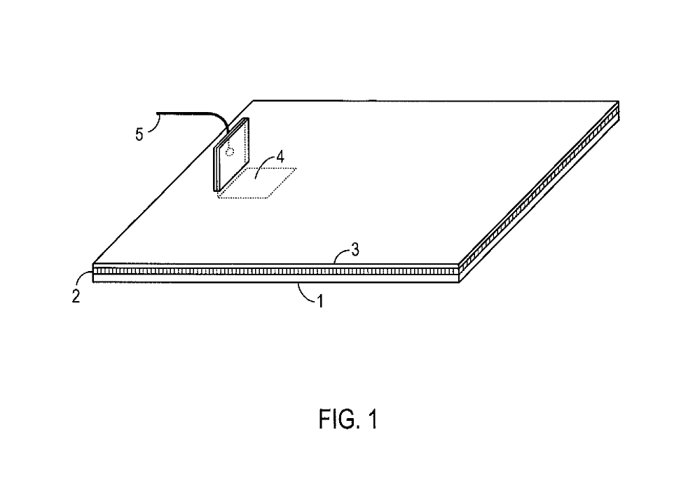

FIG. 1 shows schematically such an electrode comprising: (1) a capacitive carbon layer containing functionalized ultra-long carbon nanotubes, other allotropes of carbon with sufficiently high active surface area, and optionally other fibers or particulate materials;

(2) a graphite foil substrate onto which the capacitive carbon layer is deposited; the graphite foil acting as a current collector;

(3) a layer of polymeric lacquer;

(4) an L-shaped copper foil attached to the free side of the graphite foil substrate; and

(5) a wire soldered to the vertical portion of the copper foil; the copper foil and the foil-wire junction being completely encased in lacquer.

B. Electrode Testing Methodology

The following set-up was used for testing of the electrodes. First, a wet cationic ion-exchange membrane was placed onto the capacitive carbon layer of one electrode. Similarly, a wet anionic ion-exchange membrane was placed onto the capacitive carbon layer of the other electrode. The electrodes and their respective ion-exchange membranes were then spaced using a 1.3 mm thick two-layer plastic mesh with the fibers in the first layer oriented at 90 degrees to the fibers in the second layer.

The electrode assembly was encased in a clear Plexiglas® housing designed such that water could enter the enclosure and circulate only between the electrodes along the fibers of the mesh-spacer without wetting the back side of the electrodes. This unit which contained two carbon nanotube-based electrodes are herein referred to as a plate unit.

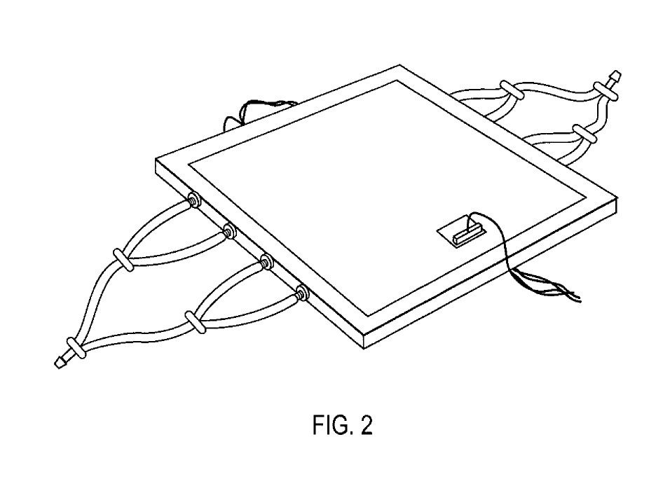

FIG. 2 shows an image of a plate unit comprising a clear Plexiglas® housing containing two carbon nanotube-based electrodes according to an embodiment of the present invention. The housing was designed such that water can enter the enclosure and circulate only between the electrodes. The tubes allow the unit to be connected to other units. The wires allow the electrodes to be connected to a power supply.

Nine plate units were built and plumbed in series using flexible clear tubing such that water may enter a plate unit, move between the electrodes, exit the unit and enter the next plate unit.

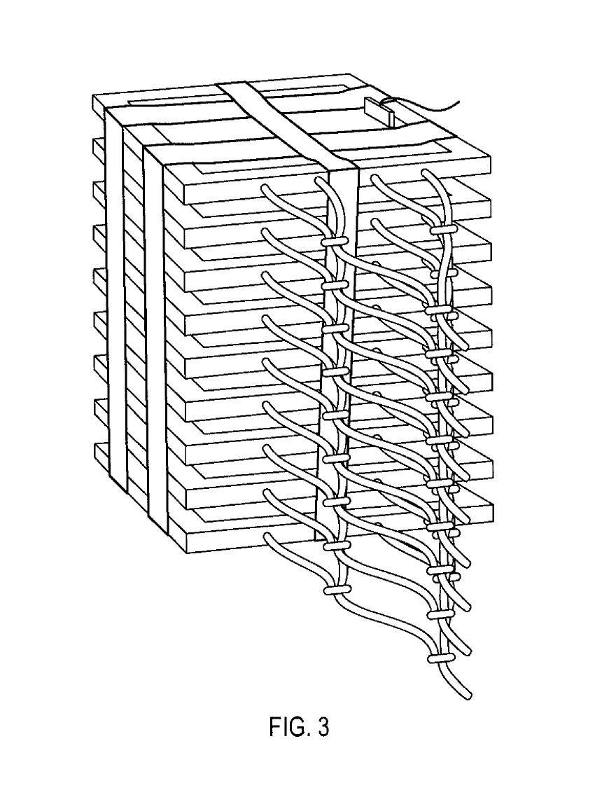

FIG. 3 shows a stack of nine plate-units like the one shown in FIG. 2, plumbed in series using flexible clear tubing such that water may enter a plate unit, move between the electrodes, exit the unit and enter the next plate unit. All nine units are connected via wires to the poles of a power supply.

All electrodes with an cationic ion-exchange membrane were connected in parallel to the same potential. During the charging phase this potential is negative.

All electrodes with an anionic ion-exchange membrane were all connected to the same potential. During the charging phase this potential was positive.

Eventually, nine of the electrodes were connected to the positive pole of a power supply while the other nine were connected to the negative pole.

With the power supply generating a potential difference of about 1-2 VDC, a fixed amount of water containing either sodium chloride (600-700 ppm) or calcium chloride (350-360 ppm; concentration expressed as hardness in terms of equivalent CaCO₃) was circulated in a closed loop through the serial assembly of plate units at a flow rate of 11/min for a given length of time, and the final concentrations were measured with either a conductivity meter for sodium chloride, or by titration for hardness in terms of equivalent CaCO₃. In one embodiment, the processing time ranged from about 1 to 8 hours.

After the prescribed times, it was found that the salinity of the water had decreased from about 600-700 ppm to 12-14 ppm, while the hardness decreased from about 350-360 ppm to 2-3 ppm equivalent CaCO₃.

The actual voltage on the electrodes as well as the current through the circuit, measured with probes mounted on a 1 mOhm resistor, was monitored and recorded using a high definition digital oscilloscope.

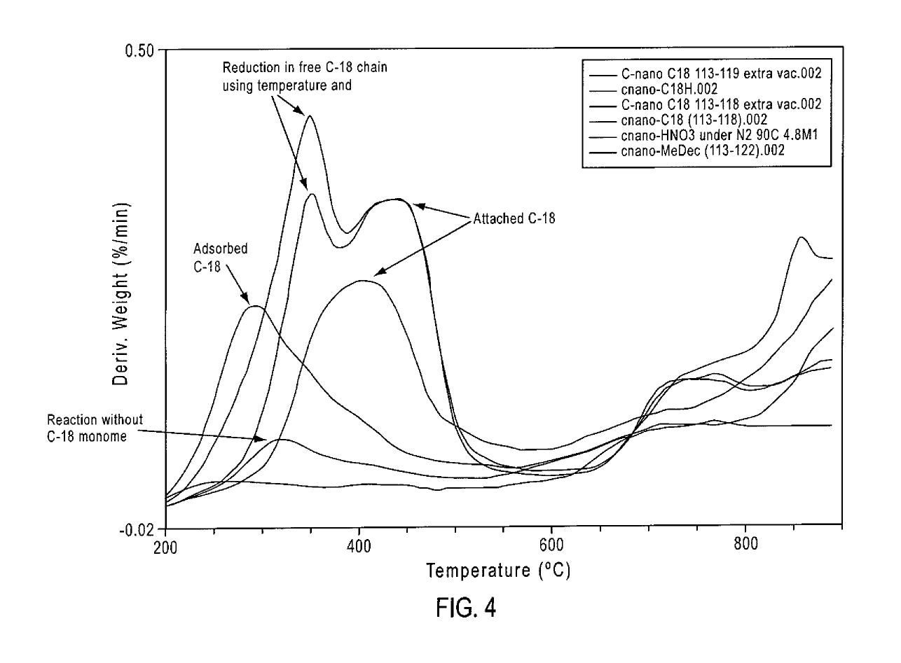

The goal of the chemistry experiments described in FIG. 4 was to understand the chemistry of carbon nanotube and use it to attain super hydrophobic surfaces within the media. As a result, the inventors functionalized the carbon nanotube through various techniques and assessed hydrophobic properties. One way to measure such properties was to measure the water contact angles on the films of functionalized carbon nanotube by using a tool that was specifically fabricated in-house to measure contact angle. The water-CNT contact angles were then measure.

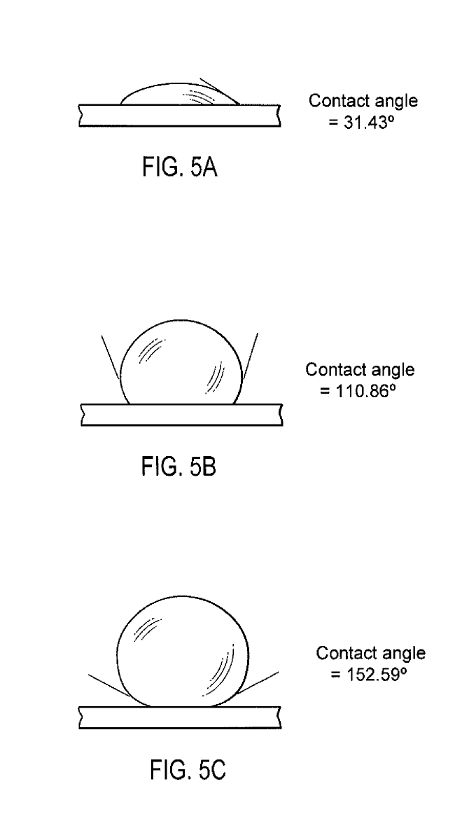

FIG. 5 presents the water contact angles on some of the functionalized carbon nanotube films. The carbon nanotube samples with C-18 attached chains achieved the highest contact angles of 152.39 degrees. However, contact angle of 110-135 degrees were achieved by other mechano-chemical functionalization techniques (microfluidics). Acid treatment was found to reduce the contact angle drastically and hence cannot be used for functionalization of carbon nanotube. However, acid treatments are needed to achieve dispersions in the media. Hence, additional reactions, such as C-18 chain addition, are needed to enhance the contact angle of carbon nanotube. Through this functionalization, the inventors discovered that they could modulate the hydrophobicity of the electrode materials to maximize the properties as required by the application environment.

In various embodiments, the electrodes described herein may be used as capacitive elements in coaxial cables, land vehicles, ocean vehicles, air craft, space craft, robotics, computers, displays, sensors, machine tools, electrical magnetic shielding, batteries, capacitors, fluid purification devices, fluid separation devices, fluid filtration devices, ion separation device, biological component separation devices, a device for electrolytical oxidation of contaminates in water, a capacitive deionization device for the polishing of post-reverse osmosis water, solar energy collection devices, a device for the removal of organic matter from water, radiation collection devices, a device for the removal of mineral content from hard water, or any combination thereof.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

What is claimed is:

1. A corrosion-resistant electrode comprising:
a capacitive carbon containing material comprising at least 5% of functionalized, ultra-long carbon nanotubes having a length ranging from 0.1 mm to 250 mm, wherein a majority of said ultra-long carbon nanotubes are capacitively coupled to one another, wherein said electrode has a tensile strength ranging from 10 mPa to 300 GPa.

2. The electrode of claim 1, wherein said capacitive carbon containing material further comprises (a) at least one other allotrope of carbon having a surface area of at least than 500 m²/g, (b) at least one other material having a fibrous or granular morphology, or a combination of (a) and (b).

3. The electrode of claim 1, further comprising a graphite sheet substrate, and a metal foil attached to the graphite sheet, wherein said metal foil optionally contains at least one a wire attached to the metal foil to be connected to a circuit.

4. The electrode of claim 1, wherein said ultralong carbon nanotubes are multi-walled and have a diameter ranging from 1 nm to 60 nm.

5. The electrode of claim 1, wherein said other allotropes of carbon have active surface areas ranging from 1000 to 2500 m²/g.

6. The electrode claim 1, wherein the electrode of claim 1, wherein said capacitor has a voltage across it ranging from 1 nV to 10 kV.

7. The electrode of claim 1, wherein the capacitance per unit mass of capacitive carbon containing material ranges from 80-120 Farad/g.

8. The electrode of claim 1, wherein said electrode can operate in corrosive aqueous solutions containing dissolved solids and can be used for desalination applications.

9. The electrode of claim 1, wherein said capacitive carbon layer containing is attached to the processed substrate without using any resin-like binders.

10. The electrode of claim 1, wherein said ultralong carbon nanotube material is in the geometrical form of a thread, a cable, a woven fabric, a non-woven material, a 3D printed part, a 3D woven form or any combination thereof.

11. The electrode of claim 10, wherein the said geometrical supports current density up to 3×10⁹A/cm² at frequencies from 10 Hz to a 50 THz.

12. The electrode of claim 1, which is used as capacitive elements in coaxial cables, land vehicles, ocean vehicles, aircraft, spacecraft, robotics, computers, displays, sensors, machine tools, electrical magnetic shielding, batteries, capacitors, fluid purification devices, fluid separation devices, fluid filtration devices, ion separation device, biological component separation devices, a device for electrolytical oxidation of contaminates in water, a capacitive deionization device for the polishing of post-reverse osmosis water, solar energy collection devices, a device for the removal of organic matter from water, radiation collection devices, a device for the removal of mineral content from hard water, or any combination thereof.

13. A method of making a corrosion-resistant electrode, said method comprising:
forming (a) a carbon containing mixture by dispersing and/or mixing in a liquid medium, (1) functionalized, ultra-long carbon nanotubes, (2) at least one other allotrope of carbon having a surface area of at least than 500 m²/g, and (3) at least one other material having a fibrous or granular morphology, and (b) a graphite sheet used as substrate and current collector;
cleaning the surface of a graphite sheet followed by roughening the surface of the sheet to form a processed graphite sheet substrate;
depositing the mixture onto at least one surface of the said processed graphite sheet substrate;
pressing the carbon containing mixture onto at least one surface of the said processed graphite sheet substrate to form an electrode;
at least partially drying the carbon mixture that was deposited onto the processed graphite sheet substrates and that formed the electrode; and
clamping the electrode between at least two rigid plates followed by at least one heating step.

14. The method of claim 13, wherein said at least one heating step includes a time ranging from 20-40 minutes, and a temperature ranging from 100-300° C. in air or in an inert atmosphere.

15. The method of claim 13, wherein said capacitive carbon material adheres to the surface of said processed substrate via a combination of mechanical and molecular level forces.

16. The method of claim 13, wherein said functionalized ultra-long carbon nanotubes are added to the carbon containing material in an amount equal or exceeding 5% of the amount of other allotropes of carbon.

17. The method of claim 13, wherein said ultra-long carbon nanotubes have a length ranging from 0.1 mm to 250 mm, and a diameter ranging from 1 nm to 60 nm.

18. The method of claim 13, wherein said other allotropes of carbon have active surface areas ranging from 1000 to 2500 m²/g.

19. The method of claim 13, wherein the said carbon nanotubes are functionalized by contacting the said carbon nanotube with at least one acid chosen from a nitric acid, sulfuric acid, hydrochloric acid, phosphoric acid, hydrofluoric acid, oxalic acid, acetic acid, propionic acid, butanoic acid, pentatonic acid, hexaonic acid, stearic acid, or any combination thereof.

20. The method of claim 13, wherein said ultralong carbon nanotubes are fabricated from a surface such that the said ultralong carbon nanotubes align themselves perpendicular to the said surface during the synthesis process on the said surface.
